(19) United States
(12) Patent Application Publication
(10) Pub. No.: US 2005/0007613 A1
(43) Pub. Date: Jan. 13, 2005

(54) Imaging system control panel method and apparatus

(76) Inventors: Terry M. Fritz, Boise, ID (US); Dana A. Jacobsen, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/616,075

(22) Filed: Jul. 9, 2003

(51) Int. Cl. G06F 15/00; G09G 5/00

(52) U.S. Cl. 358/1.13; 715/700

(57) ABSTRACT

An imaging system includes a display panel, and a driver for the display panel. The driver controls the display panel. The driver displays a control panel display changeable by a user.

### TECHNICAL FIELD

The present invention relates generally to imaging devices, and in particular to control panels for imaging devices.

### BACKGROUND

Imaging devices have become very commonplace in society. Nearly every user who operates a computer has use for an imaging device. Such devices take the form of printers of various types, such as ink jet printers, laser jet printers, laser printers, and the like. Other imaging devices include optical scanners, photocopiers, facsimile machines, and combination machines that have one or more of the printing, scanning, copying, and faxing functions.

Typical imaging devices, especially imaging devices for heavier uses such as office or corporate uses, as well as home type imaging devices with multiple functions or higher end home devices, have a display or control panel located on the imaging device. The display or control panels often have menus or the like that a user can access to change certain settings on the device. For example, typical printers may include selections for paper size, duplex printing, stapling, and the like. Similarly, copiers may include menus for paper size, printing density or darkness, and the like. Further, nearly all more advanced imaging devices contain within the display or control panel a series of menus for diagnostics, clearing paper jams, instructions for maintenance and the like. In some imaging devices, the menus are several layers deep, and can get quite complicated. The sheer amount of information present in control panels or displays sometimes results in displays having small type fonts that are difficult to read.

As display panel technology continues to improve, text-only displays are giving way to more usable displays. Such displays include by way of example images, graphics, and even customizable menus. As displays continue to increase in complexity and functionality, the limitations of a basic menu system become apparent. The displays are limited by functionality, and are not subject to change to suit individual users, of whom there may be many, especially on networked office imaging devices. As imaging devices become more and more multi-functional, they are used by different personnel in different ways. A rigid menu structure may suit only one or even no users.

For the reasons stated above, and for other reasons stated below that will become apparent to those skilled in the art upon reading and understanding the present specification, there is a need in the art for an improved control panel display for imaging devices.

### SUMMARY

The various embodiments described herein include an imaging system with a display panel, and a driver for the display panel. The driver controls the display panel. The driver displays a control panel display changeable by a user.

Embodiments of the invention include apparatus and methods of varying scope.

### BRIEF DESCRIPTION OF THE DRAWINGS

FIG. 1 is a block diagram of an imaging system according to one embodiment of the present invention;

FIG. 2 is a block diagram of a screen of a command program according to one embodiment of the present invention;

FIG. 2A is a view of a computer and imaging system according to another embodiment of the present invention;

FIG. 2B is a view of a GUI display according to another embodiment of the present invention;

FIG. 2C is a block diagram of an imaging system according to another embodiment of the present invention;

FIG. 2D is a view of a card access embodiment of the present invention;

FIG. 2E is a view of another embodiment of the present invention;

FIG. 2F is a block diagram of an imaging system and external computer according to another embodiment of the present invention; and

FIG. 3 is a flow chart diagram of a method according to one embodiment of the present invention.

### DETAILED DESCRIPTION

In the following detailed description of the present embodiments, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that process, electrical or mechanical changes may be made without departing from the scope of the present invention. The following detailed description is, therefore, not to be taken in a limiting sense, and the scope of the present invention is defined only by the appended claims and equivalents thereof.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present invention, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

This disclosure is directed to control of the appearance and display of the control or display panel of an imaging system such as a printer, to the imaging system itself, and to computer programs and drivers that are used with the imaging system and the display panel. The control or display panel is a graphical panel capable of displaying multiple screens including those for operation of a peripheral as well as for control of the various functions of a peripheral, and may be textual, graphical, or a combination thereof. Embodiments of the present invention allow for the changing of the aesthetic as well as functional aspects of an imaging system display panel.

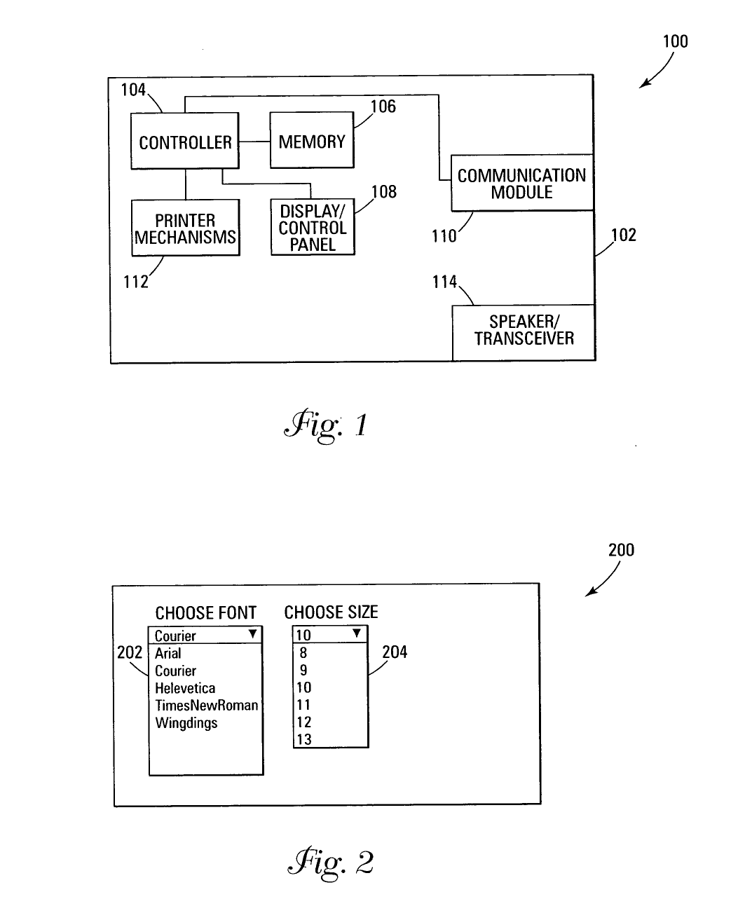

FIG. 1 shows an imaging system 100 according to one embodiment of the present invention. Imaging system 100 may be a printer, facsimile machine, photocopier, scanner, combination machine, or the like. Imaging system 100 comprises a body 102, the body housing a controller or processor 104 that controls the operation of the imaging system 100, a memory 106, a display or control panel 108, a communications module 110, and printer mechanisms 112. Imaging system may also include a speaker/transceiver 114 for provision of audible signals, or receipt of audible signals, for example by using automated voice recognition software. Such software is known in the art and will not be described further herein.

The controller 104 may be a microprocessor or it may be a simpler microcontroller running microcode. The memory 106 may be of the type used for temporary storage of data such as random access memory (RAM). Additionally, the memory 106 may be of the type used for permanent storage of data such as read only memory (ROM), programmable read only memory (PROM), and/or memory cards. Other types of memory, semiconductor, magnetic, optical, or other types, can be included as memory. The memory 106 can store self-test data and self-test results. The memory can also store tasks to be executed by the controller 104 during the idle time that the controller 104 is not executing a print job. The communications module 110 includes any network interface cards (e.g., Ethernet) required to interface the imaging system 100 to a network (not shown). In another embodiment, the communications module 110 is simply a USB port, IEEE 1394 port (FIREWIRE), infrared, or other type of port for coupling the printer to a computer.

The controller 104 is also coupled to and controls the printer mechanisms 112 of the imaging system 100, which may comprise a printer. In the embodiments of the present invention, the printer mechanisms 112 include those components found in printers, and as such will vary from printer to printer. For example, the printer in one embodiment is an ink jet printer including any functional inkjet print head(s), a print head carriage assembly, a roller that feeds the print media through the printer, and the like. In another embodiment, the printer is a laser printer having laser printer components including a toner cartridge with a toner supply, a fuser, and the like.

The display 108 in this embodiment is configurable by a user to show functions and aesthetic aspects of the display screen that are suitable to or needed by the user. For example, the display is configurable to allow a user to choose a specific font for displaying text, a font size, a background color, a wallpaper, or the like. Further, the display is configurable to display functional options that the user desires to be present on the display. As has been mentioned, typical imaging system displays are static. Menus allow a user to find and use functions of the imaging system according to a rigid structure that does not change to accommodate the preferences of a user. In an office situation in which many users may use an imaging system, especially a multi-function imaging system such as are becoming popular in an office setting, each of the multiple users of a particular imaging system may use the system for very different functions. Further, each user may have a specific look and feel preferences that the user finds to be most efficient for ease of use and functionality of the imaging system. Still further, the display in another embodiment is configurable to display text in other languages, and is configurable as described above with respect to other display characteristics.

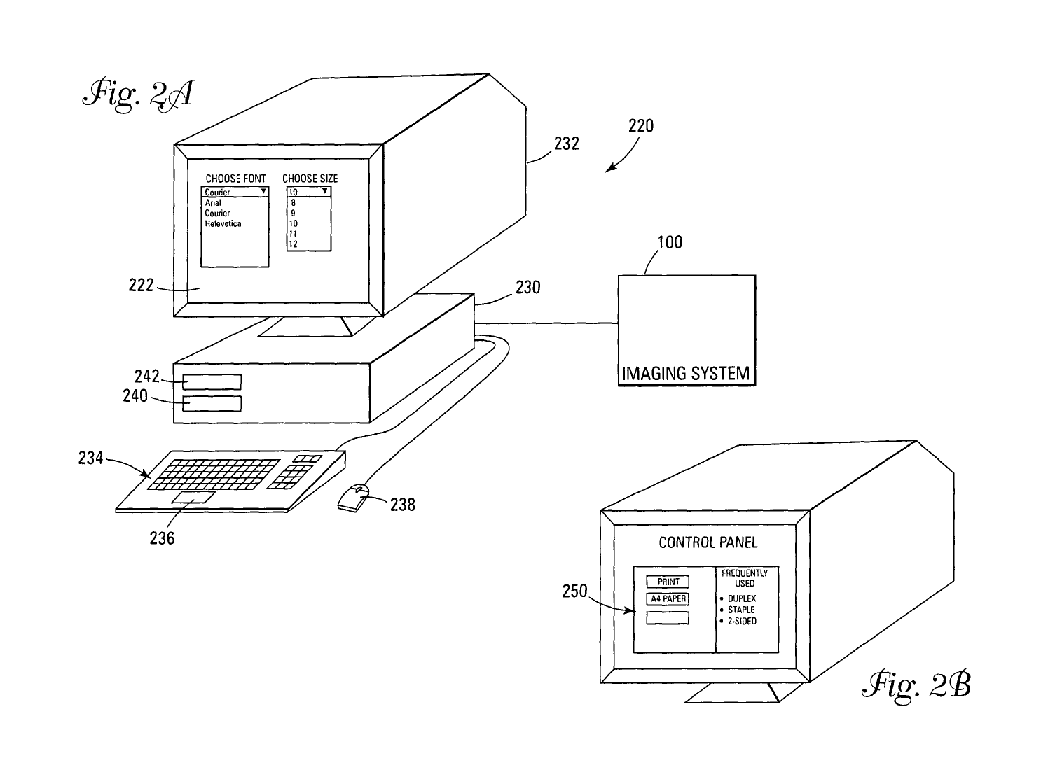

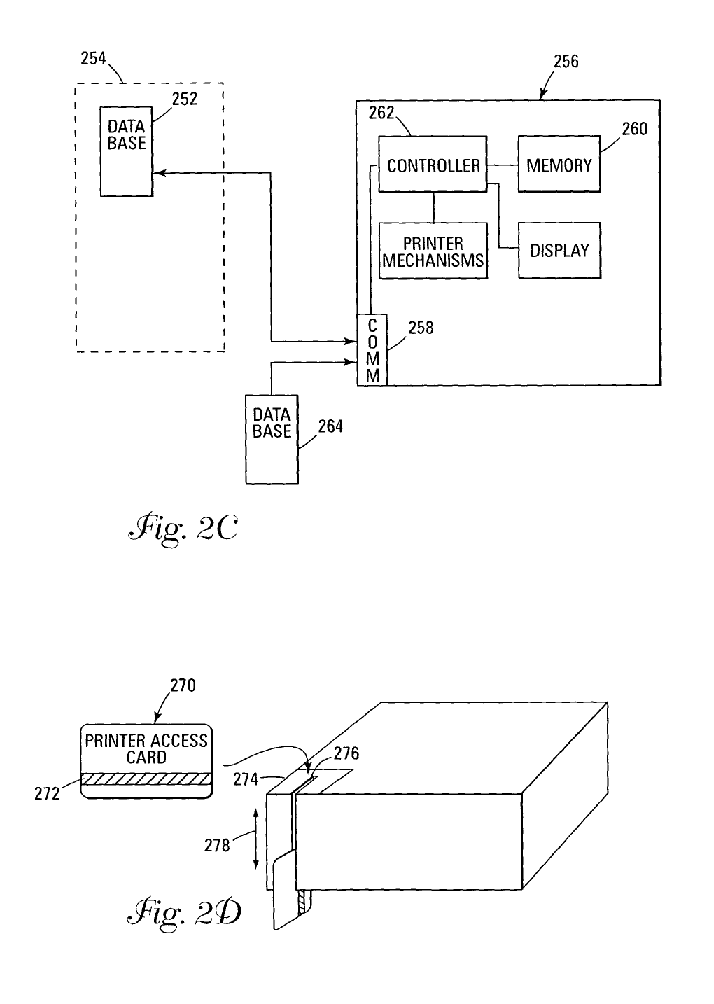

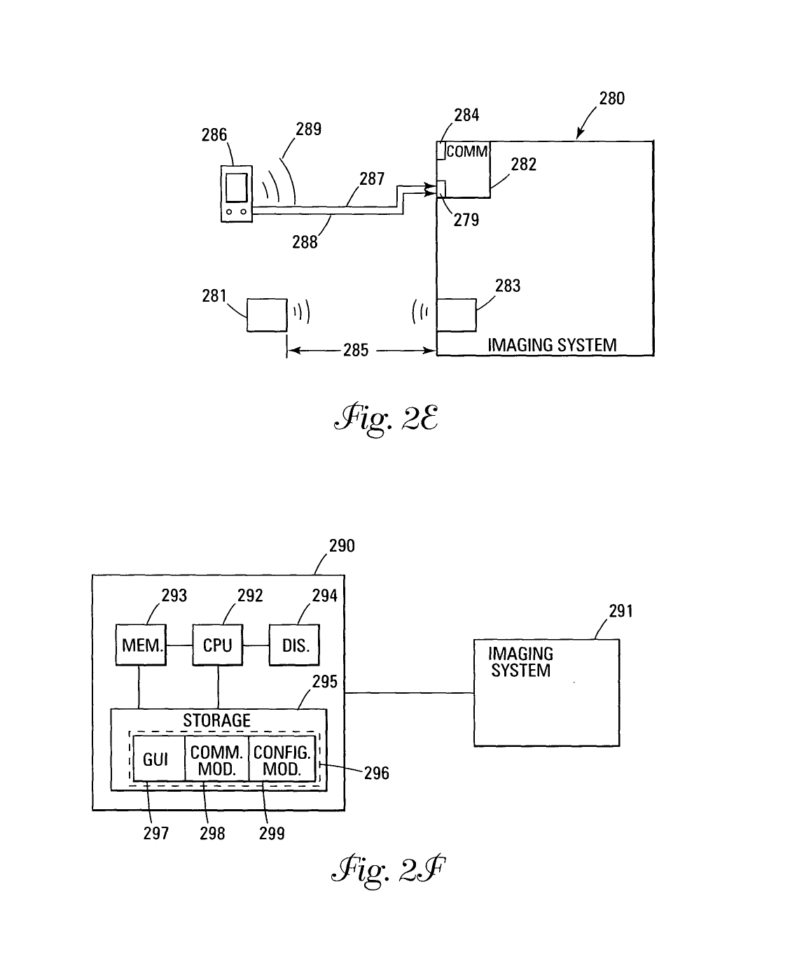

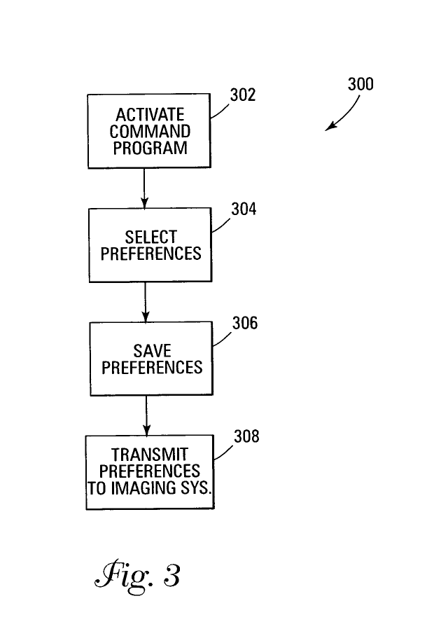

In one embodiment, the display of the imaging system 100 may be configured by each individual user to reflect a display that accommodates each user's preferences. A host application, residing on a computer or the like at the user's desk, serves as a command program to modify the settings of the display at the printer. One embodiment of such a command program uses a graphical user interface (GUI) to allow a user to select or modify a display panel set of settings. One embodiment of a representative screen of a GUI 200 for such purposes is shown in FIG. 2. For each of the settings that the command program allows a user to change, there is a menu item for such change. For example, a listing of available fonts 202 and font sizes 204 for the display panel is shown in list form on a choice screen of the GUI 200. In another embodiment, shown in FIG. 2A, a user's computer or PC 220 running a GUI 222 such as that described herein is shown operatively connected to an imaging system such as imaging system 100. The PC 220 has a central processing unit 230 operatively coupled to monitor 232, keyboard 234 having touchpad 236, and a pointing device 238 such as a mouse, and includes a processor, random access memory, read only memory, and one or more storage devices, such as a hard disk drive, floppy disk drive 240, CD-ROM/DVD-ROM/combo drive 242, or the like. The memory, hard drives, floppy disks, and the like are types of computer readable media.

In another embodiment, a driver is used to control the operations of the imaging system. A driver is a sequence of program instructions that controls an input/output device, such as an imaging systems. It is typically stored and/or executed on a computer, and works to communicate between an operating system and a peripheral. The driver in various embodiments includes a GUI, a command program, and a configuration program for operating the functions and configuration of the imaging system.

GUI 200 contains a number of screens for various choices that a user may wish to make with respect to the appearance of the display panel, including by way of example only and not by way of limitation, font, font size, background color, borders including optional display borders, graphical images such as bitmaps, wallpapers, menu selections, bullet items, audio options, and the like. It should be understood that the list of configurable items is not all inclusive, but any display item that has more than one choice for its display is amenable to use with the embodiments of the present invention.

Further, the GUI 200 in another embodiment allows a user to configure the actual functions of the imaging system, such as choosing which functions of the imaging system are available from each menu. For example, one user may wish to have custom buttons for a specific type of print job or copy job that user uses regularly. The command program 200 of the present embodiment allows a user to configure such options. The GUI for the command program shows at the user's desktop a representative image of what the display will look like at the printer. When the user is satisfied with the appearance and functionality of the display, the user saves the configuration. A sample screen 250 of the GUI is shown in FIG. 2B.

The saved configuration is transmitted or otherwise sent to the imaging system 100 from the command program at the host computer when the user desires to use the imaging system. Such transmission may be accomplished in a variety of ways, for example by transmitting over a network connection, a serial connection, a parallel connection, an infrared or radio frequency (RF) connection, or the like. Further, in another embodiment, each saved configuration has a unique name or identifier associated with it, and the configurations are stored in the memory of the imaging device. In this embodiment, when a user wishes to invoke his or her saved configuration, the user enters the unique identifier at the display panel or control panel of the imaging device, which loads the desired saved configuration for the user.

In another embodiment, a number of preset configurations are stored in the user's personal computer or at the imaging system. A user may, using either an identifier at the display panel of the imaging device or the command program at the user's desk, choose one of the preset configurations. Such preset configurations include by way of example only and not by way of limitation, theme configurations, specific job-type configurations, and the like. For example, one theme configuration may adjust the display to look like a typewriter, and another may adjust the display to look like an arcade game. Still other configurations include specific wallpapers or backgrounds, such as scenery or the like. It should be understood that any configuration capable of display on the display panel of an imaging system is amenable to use with the embodiments of the present invention.

The preset configurations may also be available from a database 252 stored on a network 254 accessible to an imaging system such as imaging system 256 shown in FIG. 2C. The database is accessible through the communications port 258 and ultimately the memory 260 or controller/processor 262 of the imaging system 256, or in other embodiments is stored in an external database 264 accessible by the imaging system via a network connection or a direct cable connection to a magnetic media or the like storing the database.

In one embodiment, input devices on a user's computer or on the control panel of the imaging system itself are disabled so that accidental operation of, for example, a mouse button, does not change a menu choice. Such a disabling can be performed in a variety of ways as are known in the art. For example only, and not by way of limitation, certain components of a keyboard such as a touchpad or of a mouse such as a mouse button are disabled by selecting specific settings within a command program for the keyboard or mouse, such as within the system controls of a computer. This allows multiple input options to be available without creating unnecessary complexity or difficulty of use.

In another embodiment, the imaging system 100 acknowledges receipt of a set of preferences or a changing of preferences with an audible or visible signal, such as a flashing display, an audio tone or synthesized voice, or the like. In one embodiment, audio feedback is mutable so that in an office environment no undue disturbance of a work area is created.

In another embodiment, the display 108 at the imaging system 100 has a GUI for changing the configuration. In this embodiment, a command program such as the command program discussed above is stored in the memory of the imaging system, and is executed on the processor of the imaging system when a user so desires. The user then has the option of transmitting the configuration to the command program on his or her desktop for later reconfiguration or editing.

In yet another embodiment, when the individual user configurations are stored at the imaging system, access by other methods to the stored configurations are used. For example, stored configurations are retrievable in various embodiments through voice access, touchpad access, keypad access, or the like. In a voice access method, when a user approaches an imaging device on which his or her stored configuration resides, the user simply identifies the configuration using his or her voice, for example by saying the user's name or employee number. The voice access hardware and software for the imaging system then retrieves the correct configuration, and displays it on the display. Other embodiments include audio output or other forms of communication to a user, such as for the visually impaired.

In yet another embodiment, individual user preferences are stored on a magnetic stripe on an access card or the like. A card reader on the imaging system is configured to read the stored configuration information from the magnetic stripe of the card, and once the configuration is read, the individual configuration is displayed on the display of the imaging device. In this embodiment, users who use multiple different imaging devices can load their individually configured display onto any imaging system equipped to provide such a configurable display. This may be especially desirable for users who travel to multiple locations within the same company, where the entire company uses similar equipment, as is common among larger companies. FIG. 2D shows an imaging system such as devices 100 or 256 described above, equipped with a card reader 274. Card reader 274 has a card slot 276 for receiving a card such as card 270 having a magnetic stripe 272 with information encoded thereon. Card 270 is swiped through the reader slot 276 in a direction as indicated by arrow 278. The card reader 274 reads the information encoded in the magnetic stripe 272, and conveys that information to the internal controller or processor of the imaging system.

In another embodiment, shown in FIG. 2E, a command program such as that described above is available on a personal digital assistant (PDA) such as PDA 286, handheld computer, or the like, with the same functionality of the command program on a user's desktop computer. Transmittal of the saved preferences from PDA 286 in such an embodiment may be via a serial 287 or parallel 288 link to a user's desktop or directly to the imaging system 280's parallel or serial ports 279, as shown. In another embodiment, information may be transmitted directly from the PDA to the imaging system 280 via a transmission protocol available to the PDA, such as infrared or the like 289, to a receiving port such as infrared port 284 on imaging system 280's communications module 282. In another embodiment, a wireless or radio frequency device 281 with a proximity activation system, or the like, communicates with a receiver/transponder 283 of imaging system 289. In this embodiment, a cellular telephone or other wireless device with a communication protocol such as Blue Tooth or the like activates the receiver/transponder 283 when the wireless device is within a predetermined proximity of the imaging system indicated by distance 285, which is adjustable depending upon the device and desire of the user. Such a wireless device could also contain a radio frequency (RF) device or the like that communicates with an active or passive RF identification tag on the imaging system 289.

In another embodiment shown in FIG. 2F, a computer or host 290 is operatively connected to an external imaging system 291. The host 290 comprises a central processing unit 292 connected to memory 293, display (such as a monitor) 294, and storage 295. Storage 295 has stored therein a command application 296 that comprises a graphical user interface 297, a command module 298, and a configuration module 299, as have been described herein. The GUI 297 is displayed on the display 294. The command module 298 allows a user to re-configure a display panel on the imaging system 291, and to see a representation of the imaging system display panel on the display 294. The configuration module 299 stores a configuration once a user has determined that the configuration is what is desired, and transmits the configuration to the imaging system 291 for display on the imaging system display panel.

After a predetermined period of inactivity of the imaging system, the display in one embodiment reverts to a standard or default display pattern.

A method 300 for configuring an imaging device such as a printer is shown in flow chart diagram in FIG. 3. Method 300 comprises activating a command program in block 302, selecting preferences in block 304, saving preferences in block 306, and transmitting preferences to an imaging system in block 308. Selecting preferences in block 304 may include viewing the results of those preference choices on a GUI such as that described above, and modifying the selected preferences until they are satisfactory to the user.

The methods shown in the Figures may be implemented in whole or in part in various embodiments in a machine readable medium comprising machine readable instructions for causing a computer or processor to perform the methods. Such machine readable media may include software modules and computer programs. The computer programs may comprise multiple modules or objects to perform the methods or the functions of various apparatuses described herein. The type of computer programming languages used to write the code may vary between procedural code type languages to object oriented languages. The files or objects need not have a one to one correspondence to the modules or method steps described depending on the desires of the programmer. Further, the method and apparatus may comprise combinations of software, hardware and firmware as is well known to those skilled in the art.

### CONCLUSION

The embodiments of the present invention increase the ease of use of imaging systems such as printers by allowing a user to customize the appearance. For example, traditional printer displays are small, and often contain small fonts and text that are difficult to read, especially in an office lighting situation or arrangement. Embodiments of the present invention allow for the changing of a font to a more readable font, the changing of size of a font on the display to make the display more easy to read, and the like. Other embodiment include the changing of menu items to more specifically reflect the user's typical printing usage.

The various embodiments of the present invention are implemented in various ways, such as by activating a control module to change the specific features at one of a number of locations, and in one of a number of ways. In one embodiment, the user keys a code into the printer at a keypad, the code activating a specific user preference created by an individual user. Such a preference set is created in one of a number of ways, including creating it at the printer using a keypad and creating a preference file at a computer. In the second case, the preference file is transferable to the printer by, for example, serial or parallel data transfer, network data transfer, infrared transfer, and the like.

In other embodiments, a plurality of preferences are stored in the printer, and the preferences are capable of activation from the user's computer, from a handheld device such as a personal digital assistant, from the control panel keypad of the printer, or by voice activation at the printer. It should be understood that other ways to transfer profiles or to activate profiles are well within the scope of those of ordinary skill in the field, and are within the scope of the present invention.

Although specific embodiments have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any such adaptations or variations of the invention. It is manifestly intended that this invention be limited only by the following claims and equivalents thereof.

1. An imaging system coupled to a computer, comprising:
an imaging system display; and
a driver to operate the display, the driver for receiving a display configuration and displaying a screen representative of the imaging system display configuration on a computer display, the driver resident on the computer.

2. The imaging system of claim 1, wherein the driver comprises a plurality of commands for performing a plurality of operations on the display to change the imaging system display appearance.

3. The imaging system of claim 1, and further comprising:
a configuration program adapted to run on a processor to create imaging system display configurations.

4. The imaging system of claim 3, wherein the command program further comprises:
a graphical user interface to display a representation of the imaging system display on the computer display.

5. A graphical panel for an imaging system, comprising:
a configurable display; and
a command program to control the configurable display, the command program usable to re-configure the display.

6. The graphical panel of claim 5, wherein the command program is loadable on an external processor, the external processor connectable to the display to transmit a display configuration to the display.

7. The graphical panel of claim 5, and further comprising:
a configuration program having a plurality of commands for generating the display configuration, and connectable to the driver to transmit the display configuration to the driver.

8. The graphical panel of claim 7, wherein the configuration program is loadable on an external computer, the external computer connectable to the command program to transmit a display configuration to the command program.

9. The graphical panel of claim 7, wherein the configuration program comprises:
a menu item command;
a font command;
a font size command;
a color command;
a language command; and
a background command;
wherein each of the commands controls a property of the display, and each of the commands is adjustable by a user to the user's preference for each property.

10. A host-based command application, comprising:
a graphical user interface to display a representation of a front panel display for an imaging system;
a command module, the command module adapted to allow re-configuration of the graphical user interface to display a new representation of the front panel display; and
a configuration module to transmit the new representation to an imaging system.

11. The application of claim 10, wherein the configuration module comprises:
a command program adapted to run on a processor to create display configurations.

12. The application of claim 11, wherein the command program further comprises:
a graphical user interface to display a representation of the front panel display on the graphical user interface.

13. The application of claim 10, wherein the host-based application resides on a computer external to an imaging system.

14. The application of claim 10, wherein the host-based application resides on an imaging system.

15. The application of claim 10, wherein the host-based application resides on a personal digital assistant.

16. An imaging system, comprising:
a body;
a controller;
a memory connected to the controller;
a printer mechanism operatively connected to the controller;
a display operatively connected to the controller; and
a communications module connected to the controller, the communications module adapted to receive an external display configuration and to transmit a received display configuration to the controller.

17. The imaging system of claim 16, and further comprising a command program having a plurality of commands for generating the display configuration.

18. The imaging system of claim 17, wherein the command program is external to the body.

19. The imaging system of claim 17, wherein the command program is loadable on an external computer, the external computer connectable to the communications module to transmit a display configuration to the controller via the communications module.

20. The imaging system of claim 17, wherein the command program comprises:
a menu item command;
a font command;
a font size command;
a color command;
a language command; and
a background command;
wherein each of the commands controls a property of the display, and each of the commands is adjustable by a user to the user's preference for each property.

21. The imaging system of claim 17, wherein the command program is accessed via a keypad.

22. The imaging system of claim 17, wherein the command program is accessed via voice recognition.

23. The imaging system of claim 17, wherein the command program is accessed via a touchpad.

24. The imaging system of claim 17, wherein the command program is accessed via a graphical user interface.

25. The imaging system of claim 17, wherein the command program is accessed via a magnetic stripe card reader.

26. The imaging system of claim 17, wherein the command program is accessed at a distance from the command program via a wireless access device.

27. The imaging system of claim 26, wherein the wireless access devices is a cellular telephone.

28. An imaging system, comprising:
a controller;
a memory connected to the controller;
a printer mechanism operatively connected to the controller;
a display panel; and
a driver for the display panel, the driver to control the display panel, and to display a control panel display changeable by a user.

29. A method of configuring a display for an imaging system, comprising:
selecting a set of user preferences for the display of the imaging system;
saving the set of user preferences; and
transmitting the set of user preferences to the imaging system.

30. The method of claim 29, wherein selecting a set of user preferences comprises:
displaying a first graphical representation of the display;
selecting a set of display preferences; and
displaying a second graphical representation including the selected preferences, the second graphical representation being different from the first graphical representation.

31. The method of claim 29, wherein saving the set of user preferences comprises:
uniquely identifying the set of user preferences; and
storing the set of user preferences in a user preference set database.

32. A machine readable medium comprising a set of instructions for causing a processor to perform a method, the method comprising:
displaying a first graphical representation of a display for an imaging system;
displaying a second graphical representation of the display when a set of user preferences is changed;
saving the set of user preferences; and
transmitting the set of user preferences to the imaging system.

33. The machine readable medium of claim 32, wherein saving the set of user preferences comprises:
uniquely identifying the set of user preferences; and
storing the set of user preferences in a user preference set database.

34. The machine readable medium of claim 32, wherein transmitting the set of user preferences comprises:
sending a selected set of user preferences to an imaging system via a transmission link.

35. A method of reconfiguring a display for an imaging system, comprising:
storing a plurality of uniquely-identified display configurations in the imaging system;
activating a selected one of the display configurations; and
configuring the display according to the activated display configuration when that display configuration is activated.

36. The method of claim 35, wherein activating a display configuration comprises:
speaking a command to a voice-activated command module on the imaging system.

37. The method of claim 35, wherein activating a display configuration comprises:
transmitting an activation command to the imaging system from an external source.

38. The method of claim 37, wherein transmitting comprises:
sending an infrared signal.

39. The method of claim 37, wherein transmitting comprises:
transmitting from an external computer.

40. The method of claim 37, wherein transmitting comprises:
sending a radio frequency signal.

41. A method of operating an imaging system, comprising:
programming individual user imaging system display preferences remotely to the imaging system;
transferring the individual user preferences to the imaging system; and
operating the imaging system using a display of the individual user imaging system display preferences.

42. A command program for an imaging system, comprising:
means for selecting a set of user preferences for the display;
means for saving the set of user preferences; and
means for transmitting the set of user preferences to the imaging system.

43. The command program of claim 42, wherein the means for selecting a set of user preferences further comprises a command program having a plurality of commands for generating the set of user preferences.

44. The command program of claim 42, wherein the means for selecting a set of user preferences further comprises:
means for displaying a graphical representation of the display;
means for selecting a set of display preferences; and
means for displaying a new graphical representation including the selected preferences.
